(19) United States
(12) Patent Application Publication
(10) Pub. No.: US 2026/0326811 A1
(43) Pub. Date: Oct. 22, 2026

(54) HANDWHEEL ACTUATOR AND STEERING WHEEL ARMATURE ASSEMBLY FOR A STEER-BY-WIRE STEERING ASSEMBLY

(71) Applicant: Chassis Autonomy SBA AB, Trollhättan (SE)

(72) Inventor: Kristoffer Jidetoft, Trollhättan (SE)

(21) Appl. No.: 19/486,227

(22) PCT Filed: May 23, 2024
(86) PCT No.: PCT/SE2024/050503

§ 371 Date: Nov. 20, 2025

(30) Foreign Application Priority Data
May 25, 2023 (SE) 2330237-5

(51) Int. Cl. B62D 1/04; B62D 1/08; B62D 5/04; B62D 15/02

(52) U.S. Cl. CPC B62D 1/046; B62D 1/08; B62D 5/0403; B62D 15/0215

(57) ABSTRACT

A handwheel actuator for a steer-by-wire steering assembly and a steering wheel armature assembly comprises a steering column with a steering column shaft, a steering wheel armature having at least one spoke mounted to the steering column shaft, and a component protruding through the steering wheel armature. The at least one spoke is rotatable from a first spoke position to a second spoke position. The component is fixed with respect to the steering column and positioned outside the range of movement of the at least one spoke. This innovative design allows for improved functionality and customization of the steering wheel assembly in various vehicle types and driving scenarios.

### CROSS REFERENCE TO RELATED APPLICATIONS

This application claims priority to International Application No. PCT/SE2024/050503, filed May 25, 2024, which claims priority to Sweden Application No. 2330237-5 filed May 25, 2023, the contents of both of which are incorporated herein by reference in their entirety.

### FIELD

The technology relates to the field of automotive engineering, specifically to steering systems for vehicles and in particular steer-by-wire steering assemblies.

### BACKGROUND

Steering systems in vehicles have evolved significantly over the years, with the introduction of various technologies aimed at improving the driving experience, safety, and overall performance of the vehicle. One such technology is the steer-by-wire system, which replaces the traditional mechanical linkage between the steering wheel and the vehicle's wheels with an electronic system. This electronic system translates the driver's input from the steering wheel into electronic signals, which are then used to control the vehicle's wheels.

In conventional steering systems, a clock spring is used to maintain electrical connections between the steering wheel and the vehicle's electrical system. The clock spring is a wound ribbon cable that allows for the rotation of the steering wheel while maintaining a continuous electrical connection. However, the clock spring has several limitations, including a limited number of electrical connections and limited data/bandwidth capabilities. These limitations can restrict the implementation of new functionalities, such as display screens, mobile interfaces, and other advanced features in the steering wheel.

Furthermore, the clock spring can also introduce additional mass and inertia to the steering wheel, which can negatively impact the steering feel and responsiveness. Additionally, the clock spring can wear out over time, leading to potential failures in the electrical connections and the need for replacement.

There remains a need for an improved steering wheel assembly for steer-by-wire systems that can overcome the limitations of the clock spring, provide enhanced data/bandwidth capabilities, and enable the integration of advanced features in the steering wheel. Additionally, there is a need for a solution that can reduce the mass and inertia of the steering wheel, improve the steering feel and responsiveness, and provide a more reliable and durable mechanism.

### SUMMARY

In a first aspect, the present disclosure provides a handwheel actuator for a steer-by-wire steering assembly. The hand wheel actuator comprises a steering column having a steering column shaft, a steering wheel armature having at least one spoke mounted to the steering column shaft, and an electrical component protruding through the steering wheel armature and fixed with respect to the steering column. The at least one spoke is rotatable from a first spoke position to a second spoke position, and the electrical component is positioned outside the range of movement of the at least one spoke.

In some examples, the steering wheel armature is rotatable less than 180 degrees in a first rotation direction and a second rotation direction from a central position.

The range of motion of the steering wheel armature may be between 90 degrees and 150 degrees in the first rotation direction and the second rotation direction.

The hand wheel actuator may further comprise a rim mounted to the steering column shaft and providing a surface for a driver to grip onto, and a steering wheel cover covering and protecting the at least one spoke.

The electrical component may be selected from a group consisting of a motor, an encoder, a sensor, control circuitry, a communication module, error detection and correction circuitry, diagnostic and monitoring circuitry, safety features, an airbag, a display screen, a mobile interaction device, and a speedometer.

The sensor may be selected from a group consisting of a torque sensor, a position sensor, an accelerometer sensor, a gyroscope sensor, a force sensor, a temperature sensor, a Hall Effect sensor, an optical encoder sensor, a magnetic encoder sensor, and a potentiometer sensor.

The hand wheel actuator may further comprise an electrical and data connection mounted through the steering wheel armature, a steer-by-wire steering actuator configured to translate electronic signals received from the steering wheel armature into physical steering movements of a vehicle. The hand wheel actuator may further comprise an electronic control unit connected to the electrical and data connection. The hand wheel actuator may further comprise a steering angle sensor electrically connected to the electronic control unit and configured to measure the angle of the steering column shaft and the direction in which it is turning.

Optionally the steering angle sensor is selected from the group consisting of a magnetic field steering angle sensor, an optical steering angle sensor, an ultrasonic steering angle sensor, a capacitive steering angle sensor, a piezoresistive steering angle sensor, a fibre optic steering angle sensor, and a rotary transformer steering angle sensor.

Optionally, the hand wheel actuator further comprises a component housing mounted fixed with respect to the steering column and configured to protect the electrical component mounted inside or around the component housing.

Optionally, the hand wheel actuator further comprises a first spoke end stop configured to engage the at least one spoke when the spoke is in the first spoke position and prevent further movement of the at least one spoke in the first rotation direction.

Optionally, the hand wheel actuator further comprises a second spoke end stop configured to engage the at least one spoke when the spoke is in the second spoke position and prevent further movement of the at least one spoke in the second rotation direction.

In another aspect, the present disclosure provides a steering wheel armature assembly for a handwheel actuator. The steering wheel armature assembly comprises a steering wheel armature having at least one spoke mountable to a steering column shaft, and an electrical component protruding through the steering wheel armature and configured to be fixed with respect to the steering column. The at least one spoke is rotatable from a first spoke position to a second spoke position when mounted to the steering column shaft, and the electrical component is positioned outside the range of movement of the at least one spoke.

### BRIEF DESCRIPTION OF THE DRAWINGS

The disclosure will now be described in more detail with reference to the accompanying drawings, in which:

FIG. 1 is a perspective view of a handwheel actuator for a steer-by-wire steering assembly according to an example;

FIG. 2 is a rear perspective view of a hand wheel actuator according to an example;

FIG. 3 is a front view of a hand wheel actuator according to an example;

FIG. 4 is another a front view of a hand wheel actuator according to an example;

FIG. 5 is a perspective cross-sectional view of a handwheel actuator according to an example; and

FIGS. 6 to 8 are schematic representations of a hand wheel actuator according to an example.

### DETAILED DESCRIPTION

The present disclosure will now be described in detail with reference to example examples. It should be understood that these example examples are provided for illustrative purposes only and are not intended to limit the scope of the present disclosure.

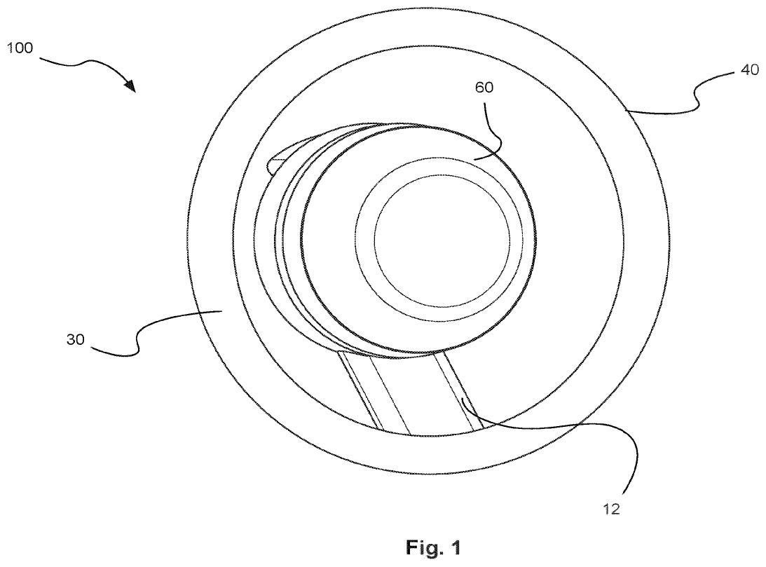

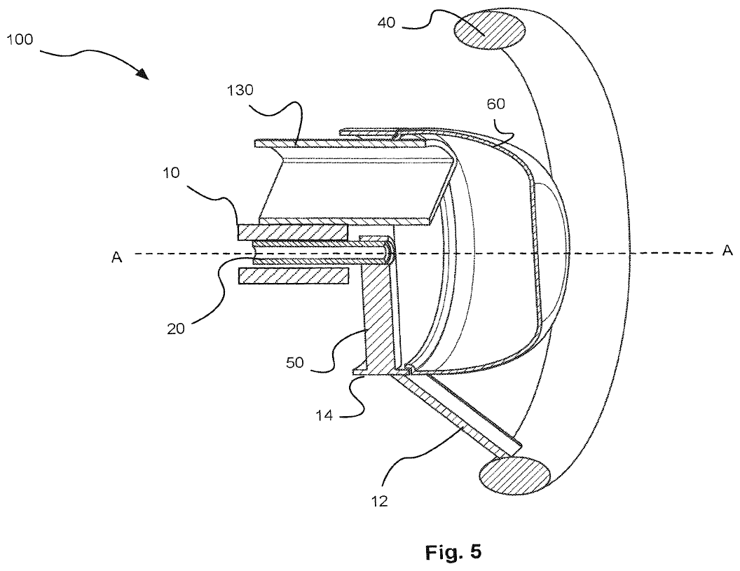

A handwheel actuator 100 is shown in FIG. 1. FIG. 1 shows a perspective view of a hand wheel actuator 100 according to an example. The hand wheel actuator 100 for a steer-by-wire steering assembly includes a steering column 10 (best shown in FIG. 5). FIG. 5 shows a perspective cross-sectional diagram of the hand wheel actuator 100. The steering column 10 is partially represented in FIG. 5 for the purposes of clarity. The steering column 10 is fixed with respect to the vehicle chassis and does not move.

The hand wheel actuator 100 also includes a steering wheel armature 30 having at least one spoke 50 mounted to the steering column shaft 20. In some examples the at least one spoke 50 is a single spoke 50 which is mounted to the steering column shaft 20.

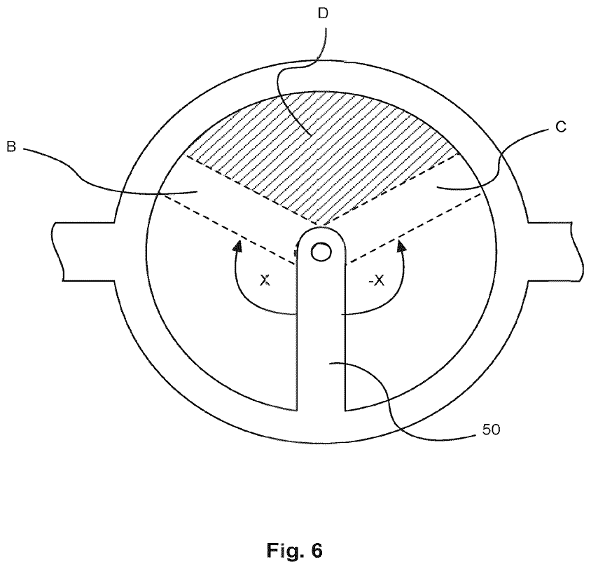

The at least one spoke 50 is rotatable from a first spoke position B (best shown in FIG. 6) to a second spoke position C (also best shown in FIG. 6). FIG. 6 shows a schematic view of the hand wheel actuator 100. In some examples, an electrical component 70 protrudes through the steering wheel armature 30 and is fixed with respect to the steering column 10. The electrical component 70 is positioned outside the range of movement of the at least one spoke 50.

The range of movement of the at least one spoke 50 is best shown in FIG. 6. As mentioned above, the at least one spoke 50 is rotatable from a first spoke position B to a second spoke position C. In FIG. 6, the steering wheel armature 30 is positioned in an armature centre position. In order to rotate the at least one spoke 50 to the first spoke position B, the steering wheel armature 30 rotates through an angle of X degrees. In order to rotate the at least one spoke 50 to the second spoke position C, the steering wheel armature 30 rotates through an angle of −X degrees.

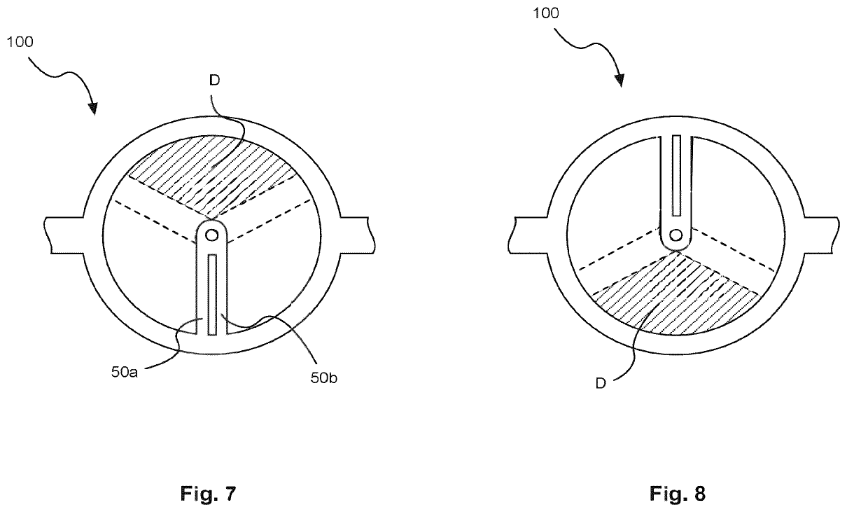

By providing only a single spoke 50, the range of movement of the steering wheel armature 30 can be increased without the single spoke 50 interfering with other parts of the hand wheel actuator 100. This will be discussed in more detail below. In some examples, the at least one spoke 50 may be a plurality of spokes 50. For example, there may be two spokes 50a, 50b as shown in FIGS. 7 and 8. FIGS. 7 and 8 are similar to FIG. 6 but show alternative arrangements for the handwheel actuator 100. The two spokes 50a, 50b can be arranged parallel to each other as shown in FIGS. 7 and 8. Alternatively, two spokes 50a, 50b can be arranged inclined to each other. It may be preferable to make the angular size of the at least one spoke 50 as small as possible.

The steering column 10 serves as the primary structural component that supports the steering wheel armature 30 and connects it to the vehicle. As mentioned above, the steering column 10 comprises a steering column shaft 20. The steering column shaft 20 is rotatable about a steering column axis A-A and rotatably mounted within the steering column 10. The steering column shaft 20 is operatively coupled to the steering actuator and rotates when the steering wheel armature 30 rotates.

In some examples, the steering column 10 and steering column shaft 20 are designed to integrate with steer-by-wire technology. Steer-by-wire technology eliminates the need for a mechanical connection between the steering wheel armature 30 and the steering mechanism. Instead, the mechanical connection is replaced with an electronic system that transmits steering inputs from the steering wheel armature 30 to the vehicle's steering mechanism. This electronic system may comprise various sensors, actuators, and control units that work together to provide precise and responsive steering control.

The integration of steer-by-wire technology into the steering column 10 and steering column shaft 20 allows for a more compact and lightweight design, as well as increased flexibility in the positioning and orientation of the steering wheel armature 30 within the vehicle's cabin. Additionally, the use of electronic components in the steering system enables advanced features and functionalities, such as customizable steering feel, adaptive steering assistance, and improved safety features.

In particular, an advantage of a steer-by-wire steering assembly, is that the physical decoupling of the steering wheel armature 30 from the steering actuator of the steering mechanism means that the steering wheel armature 30 does not need to turn more than 180 degrees in either rotational direction of the steering wheel armature 30. As described below, the steering wheel armature 30 rotates through only a portion of a turn in either direction.

Accordingly, in some examples at least one spoke 50 is rotatable from a first spoke position B to a second spoke position C and the at least one spoke 50 does not rotate beyond the first spoke position B and the second spoke position C. A static portion D of the hand wheel actuator 100 is shown in FIGS. 6 to 8. The at least one spoke 50 is configured not to rotate through the static portion D.

The static portion D as shown in FIGS. 6 and 7 is at the top of the steering wheel armature 30 and the spoke 50 is located at a 6 o'clock position when the steering wheel armature 30 is in an armature centre position. Alternatively, the static portion D as shown in FIG. 8 is at the bottom of the steering wheel armature 30 and the spoke 50 is located at a 12 o'clock position when the steering wheel armature 30 is in an armature centre position.

In some examples, the steering wheel armature 30 is rotatable less than 180 degrees in a first rotation direction and a second rotation direction from a central position. The first rotation direction and the second rotation direction are respectively indicated in FIG. 6 with the angular displacement X, −X.

In some examples, the range of motion of the steering wheel armature 30 may be between 90 degrees and 150 degrees in the first rotation direction and between 90 degrees and 150 degrees in the second rotation direction. In some other examples, the range of motion of the steering wheel armature 30 may be ±90 degrees, ±100 degrees, ±110 degrees, ±120 degrees, ±130 degrees, ±140 degrees, ±150 degrees. As shown in FIG. 6, the range of motion of the steering wheel armature 30 is optionally ±120 degrees. This leaves approximately a segment of 120 degrees of the static portion D of the hand wheel actuator 100. This range of motion limitation ensures smooth and consistent movement throughout the range, minimal play or slack in movement, low resistance and effort required for movement, adequate tactile feedback to the driver, and reliable and durable mechanism operation.

In other examples the static portion D comprises a sector of a circle having an angle of 5 degrees, 10 degrees, 15 degrees, 20 degrees, 25 degrees, 30 degrees, 35 degrees, 40 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees, 125 degrees, 130 degrees, 135 degrees, 140 degrees, 145 degrees or 150 degrees.

In some examples, the range of motion of the steering wheel armature 30 can be adjusted electronically based on driver preference, different types of vehicles, and various driving scenarios. The range of motion can be limited or expanded based on vehicle speed or driving conditions for added safety. Additionally, the steering wheel armature 30 can be locked at certain points within the range of motion for special driving modes or manoeuvres.

In some examples, the at least one spoke 50 of the steering wheel armature 30 can be made of various materials, such as metal, plastic, carbon fibre, or other suitable materials. The choice of material may depend on factors such as weight, strength, durability, and cost. The at least one spoke 50 can be adjustable or interchangeable for customization, allowing drivers to personalize their steering wheel armature 30 according to their preferences.

In one example, the hand wheel actuator 100 comprises a rim 40 mounted to the steering column shaft 20 via the at least one spoke 50. The rim 40 is connected to the at least one spoke 50 via at least one outer spoke 12. The outer spoke 12 is connected to an inner ring 14 which is connected to the at least one spoke 50. The rim 40 is configured to provide a surface for a driver to grip onto. The rim 40 allows the driver to comfortably and securely hold the steering wheel armature 30 while driving. The design and features of the rim 40 can vary as required. In some examples a steering wheel cover 60 is mounted on or fixed with respect to the component housing 130. The steering wheel cover 60 is best shown in FIGS. 1 and 5. This means that the steering wheel cover 60 does not rotate with respect to the component housing 130. Accordingly, when the user rotates the steering wheel armature 30, the steering wheel cover 60 remains static.

The inner ring 14 creates the ability to have a single spoke 50 within the handwheel actuator 100 but also maintain any outer spoke 12 configuration externally. For example, as described, there can be any suitable number of outer spokes 12 connecting the rim 40 with the inner ring 14 e.g. 1, 2, 3, 4, or 5 etc outer spokes 12 connected between the rim 40 and the inner ring 14.

The inner ring 14 advantageously seals off the internal components e.g. the electrical component 70 from the outside environment. In some examples, this can be achieved by matching the design with the static portion D of the handwheel actuator 100 e.g. the steering wheel cover 60 and an instrument panel (not shown) or other plastic trim component that will be covering the steering column 10. This is advantageous during the installation since a foreign object cannot block the single spoke 50 when steering but also allow creative design elements to be applied to the steering column 10.

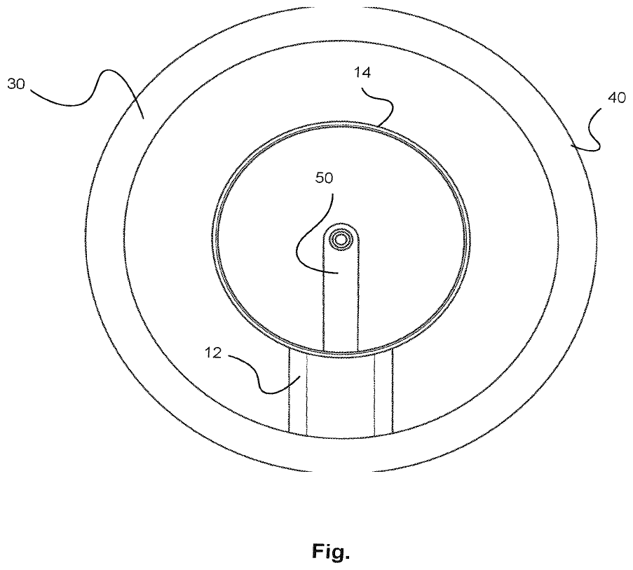

The rim 40 as shown in the Figures e.g., FIG. 4 is generally circular. FIG. 4 shows a front view of the steering wheel armature 30 without any of the other parts. The circular shape of the steering wheel armature 30 is exemplary and not essential to the hand wheel actuator 100. However, in other examples, the steering wheel armature 30 can comprise other shapes, such as square, hexagon or any other suitable shape. Indeed, in some other examples, the steering wheel armature 30 can be a yoke-type steering wheel armature 30.

In some examples, the rim 40 may comprise various materials and textures to enhance the comfort and grip for the driver. The material of the rim 40 may include, but is not limited to, leather, synthetic leather, vinyl, rubber, or other suitable materials. The choice of material can affect the overall feel and durability of the rim 40, as well as its resistance to wear and tear.

In some examples, the rim 40 may optionally comprise heating and/or cooling elements for added comfort. In some examples, the rim 40 may be equipped with paddle shifters for manual shifting in vehicles with automatic transmissions. Additionally, the rim 40 may optionally comprise other controls or buttons for added functionality, such as audio or phone control.

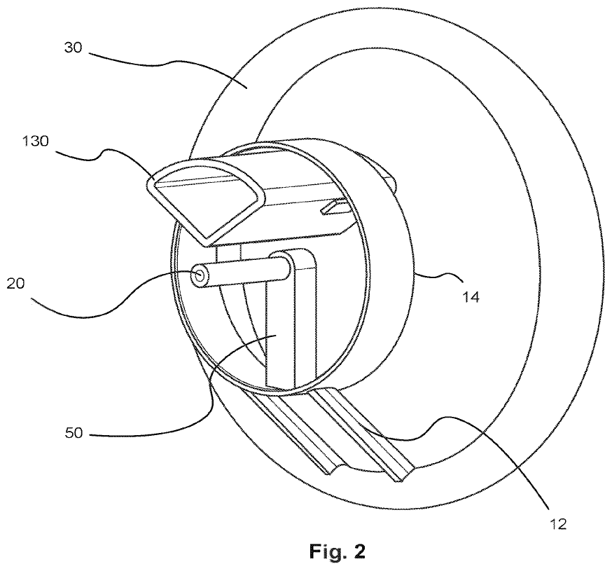

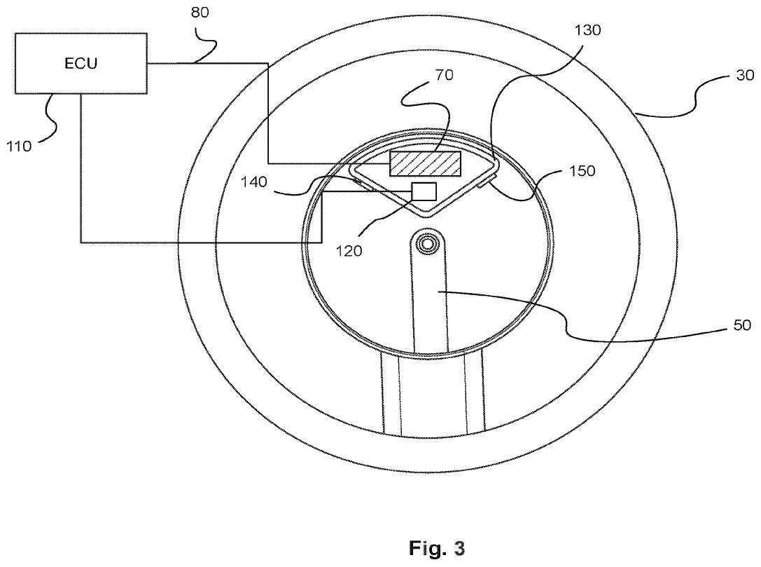

As shown in FIGS. 2 and 3, in one example, the hand wheel actuator 100 for a steer-by-wire steering assembly comprises a component 70 that protrudes through the steering wheel armature 30. In some examples the component 70 can be any component 70 of the vehicle. FIG. 2 shows a rear perspective view of the hand wheel actuator 100. In this way, the component 70 can be a non-electrical component for example a cup holder, a tray for holding accessories, a mount for receiving a portable device such as a mobile phone, a money clip, or any other non-electrical component.

The component 70 is mounted outside the range of movement of the at least one spoke 50. That is the component 70 is mounted in the static portion D. Accordingly, when the at least one spoke 50 moves between the first spoke position B and the second spoke position C, the at least one spoke 50 does not contact the component 70. The component 70 does not rotate or move with respect to the steering column axis A-A.

In some examples the component 70 is one or more various electrical components 70. The electrical components 70 may be integrated into the steering wheel armature 30 and fixed with respect to the steering column 10. These electrical components 70 are positioned outside the range of movement of the at least one spoke 50.

Accordingly, when the steering wheel armature 30 rotates, the electrical components 70 remain stationary with respect to the steering column 10. That is, the electrical components 70 do not rotate or move with respect to the steering column axis A-A. This makes implementation of functional electronic components 70 such as displays, mobile phone interfaces etc easier because no clockspring is required.

In some examples the electrical component 70 may include one or more of the following a motor, an encoder, a sensor, control circuitry, a communication module, error detection and correction circuitry, diagnostic and monitoring circuitry, safety features, an airbag, a display screen, a mobile interaction device, and a speedometer.

In some examples, the electrical component 70 may comprise various types of sensors that serve different functions in the hand wheel actuator 100. These sensors may include a torque sensor, a position sensor, an accelerometer sensor, a gyroscope sensor, a force sensor, a temperature sensor, a Hall Effect sensor, an optical encoder sensor, a magnetic encoder sensor, and a potentiometer sensor. The selection of the appropriate sensor type depends on the specific requirements of the hand wheel actuator 100 and the steer-by-wire steering assembly.

For instance, an accelerometer sensor may be used to detect acceleration and deceleration forces applied to the steering wheel armature 30. Hall Effect sensors, optical encoder sensors, magnetic encoder sensors, and potentiometer sensors may be used to detect the rotational movements and angles of the steering wheel armature 30 and provide feedback to the control unit.

In some examples, the electrical component 70 may optionally comprise control circuitry that is responsible for processing and managing the signals received from the various sensors and other components of the hand wheel actuator 100.

In a more preferred example, the electrical and data connection 80 and the ECU 110 are schematically shown in FIG. 3. In this case, the ECU 110 is remote from the hand wheel actuator 100 and located elsewhere in the vehicle. The control circuitry may be integrated into an electronic control unit 110 that is connected to the electrical and data connection 80.

The electronic control unit 110 may be responsible for processing the data received from the sensors and transmitting the appropriate signals to the steer-by-wire steering actuator (not shown) to translate the electronic signals into physical steering movements of the vehicle.

The electrical and data connection 80 are mounted through the steering wheel armature 30 in the static portion D. Accordingly, the electrical and data connection 80 is not subject to the rotational forces applied to the steering wheel armature 30. This means that the electrical and data connection 80 does not have to be a clockspring connection. Indeed, the electrical and data connection 80 can be a high bandwidth data connection. The electrical and data connection 80 and be a separate power connection and a separate data connection. The electrical and data connection 80 can be a plurality of different data connections and/or power connections.

By removing the clockspring, this enables more robust solutions that are related to ASIL classification and SAE AD Levels of steering requiring very high reliability.

Additionally, the electrical component 70 may comprise a communication module, such as Bluetooth or Wi-Fi, that enables wireless communication between the hand wheel actuator 100 and other devices or systems within the vehicle. This communication module may facilitate the exchange of data and control signals between the hand wheel actuator 100 and other components of the steer-by-wire steering assembly, as well as with external devices, such as smartphones or tablets, for added functionality and convenience.

In some examples, the electrical component 70 may comprise a phone charger and/or a phone data connection. In some examples, a phone may be mountable in the component housing 130 whilst connected to the phone charger and/or the phone data connection.

In some examples, the electrical component 70 may comprise error detection and correction circuitry that monitors the operation of the hand wheel actuator 100 and identifies any errors or malfunctions that may occur. This circuitry may be integrated into the electronic control unit 110 and may work in conjunction with the diagnostic and monitoring circuitry to ensure the proper functioning of the hand wheel actuator 100 and the steer-by-wire steering assembly.

Safety features may also be incorporated into the electrical component 70 to prevent accidental oversteer or loss of control. These safety features may include emergency stop mechanisms, fail-safe systems, and other protective measures that ensure the safe operation of the hand wheel actuator 100 and the vehicle. One such safety feature is when the electrical component 70 is an airbag. In this case, the airbag is in a fixed position and does not move when the user operates the steering wheel armature 30. This means that the airbag mounted in the steering wheel armature 30 remains static with respect to the user. Accordingly, the airbag is always mounted in the correct position, irrespective of the relative position of the steering wheel armature 30 with respect to the steering column 10.

In some examples, the electrical component 70 may comprise a display screen that presents various types of information to the driver. Since the electrical component 70 is fixed in position with respect to the steering column 10, the user can always view the display screen the right way up.

The display screen may be integrated into the steering wheel armature (30) or mounted on the steering column 10 and may be selected from various types, such as an LCD display screen, a touchscreen display, a heads-up display (HUD), a virtual display (such as augmented reality or virtual reality), a dashboard display, a driver information display (DID), a multi-function display (MFD), an infotainment display, a navigation display, a camera display (such as rear-view or surround-view camera), a blind spot monitor display, a lane departure warning display, a collision warning display, or an adaptive cruise control display.

If the electrical component 70 is a touchscreen, then the electrical component 70 can be used for user interface. In this case, the user interface remains static irrespective of the relative position of the steering wheel armature 30 with respect to the steering column 10. In some other examples, the electrical component 70 is one or more buttons e.g., volume control buttons, a horn actuator, ventilation controls, heating controls, cruise control, media controls, phone controls, electric window controls, or any other control for a vehicle system.

The display screen may provide the driver with real-time information about the vehicle's performance, navigation, entertainment, and other relevant data. The display screen may also be customizable and adaptable to the driver's preferences and needs, allowing for a more personalized and comfortable driving experience.

In some examples, the electrical component 70 may be mounted in the component housing 130 and then extend through the component housing 130 and is connected to a component mounted on the steering wheel cover 60. For example, the electrical component 70 may be mounted one the steering wheel cover 60.

In one example, the hand wheel actuator 100 for a steer-by-wire steering assembly may comprise a steering angle sensor 120 and an electronic control unit 110. Accordingly, the electrical component 70 is optionally, the steering angle sensor 120. The steering angle sensor 120 is electrically connected to the electronic control unit 110 and is configured to measure the angle of the steering column shaft 20 and the direction in which it is turning. The electronic control unit 110 is connected to the electrical and data connection 80 and is responsible for processing the data received from the steering angle sensor 120 and other sensors, as well as controlling various components of the hand wheel actuator 100.

In some examples, the steering angle sensor 120 may be selected from a group consisting of a magnetic field steering angle sensor, an optical steering angle sensor, an ultrasonic steering angle sensor, a capacitive steering angle sensor, a piezoresistive steering angle sensor, a fibre optic steering angle sensor, and a rotary transformer steering angle sensor. Each type of steering angle sensor has its advantages and specific applications, depending on the requirements of the steer-by-wire steering assembly.

For instance, a magnetic field steering angle sensor may provide high accuracy and reliability in detecting the angular position of the steering column shaft 20. An optical steering angle sensor may offer high resolution and sensitivity, allowing for precise measurement of the steering angle. A capacitive steering angle sensor may provide a robust and cost-effective solution for measuring the steering angle, while a piezoresistive steering angle sensor may offer a compact and lightweight design.

In one example, the electronic control unit 110 may be responsible for processing the data received from the steering angle sensor 120 and other sensors, such as torque sensors, position sensors, accelerometer sensors, gyroscope sensors, force sensors, temperature sensors, Hall Effect sensors, optical encoder sensors, magnetic encoder sensors, and potentiometer sensors. The electronic control unit 110 may also control various components of the hand wheel actuator 100, such as motors, encoders, control circuitry, communication modules, error detection and correction circuitry, diagnostic and monitoring circuitry, safety features, airbags, display screens, mobile interaction devices, and speedometers.

The electronic control unit 110 may communicate with the steering angle sensor 120 and other sensors through the electrical and data connection 80, ensuring efficient and reliable transmission of data and control signals. The electronic control unit 110 may also be responsible for implementing various safety features, such as emergency stop or fail-safe mechanisms, to prevent accidental oversteer or loss of control.

In some examples, the electronic control unit 110 may process the data received from the steering angle sensor 120 and other sensors in real-time, ensuring accurate and responsive control of the hand wheel actuator 100 and the steer-by-wire steering assembly. The electronic control unit 110 may also implement various algorithms and control strategies to optimize the performance of the hand wheel actuator 100, taking into account factors such as vehicle speed, driving conditions, driver preferences, and other relevant parameters.

The electronic control unit 110 may transmit control signals to the various components of the hand wheel actuator 100 through the electrical and data connection 80, ensuring efficient and reliable communication between the different parts of the system. The electronic control unit 110 may also receive feedback from the components and sensors, allowing for continuous monitoring and adjustment of the hand wheel actuator 100 and the steer-by-wire steering assembly.

In one example, the hand wheel actuator 100 comprises a component housing 130 which is mounted in the static portion D. Accordingly, the component housing 130 remains stationary when the steering wheel armature 30 rotates.

In some examples, the component housing 130 is mounted fixed with respect to the steering column 10 and is designed to protect the electrical component 70 mounted inside or around the component housing 130. The component housing 130 may be made of materials such as metal, plastic, or composite materials, which provide adequate protection against external factors such as dust, moisture, and impact. The component housing 130 may also be designed to facilitate heat dissipation, ensuring that the electrical components 70 operate within their optimal temperature range.

The component housing 130 may be designed to accommodate various types of electrical components 70, such as motors, encoders, sensors, control circuitry, communication modules, error detection and correction circuitry, diagnostic and monitoring circuitry, safety features, airbags, display screens, mobile interaction devices, and speedometers. The component housing 130 may comprise mounting points, brackets, or other attachment mechanisms to securely hold the electrical components 70 in place and ensure proper alignment and connection with the steering column 10 and the steering wheel armature 30.

In some examples, the component housing 130 comprises first and second end stops 140, 150 configured to engage the at least one spoke 50. FIG. 3 shows a first spoke end stop 140 configured to engage the spoke 50 in the first spoke position B and a second spoke end stop 150 configured to engage the spoke 50 in the second spoke position C. These components protect the electrical component 70, maintaining the structural integrity of the steering assembly, and ensuring safe and controlled steering operation.

The first spoke end stop 140 prevents further movement of the at least one spoke 50 in the first rotation direction, while the second spoke end stop 150 prevents further movement of the at least one spoke 50 in the second rotation direction.

The first and second spoke end stops 140, 150 may be designed to provide a smooth and controlled engagement with the at least one spoke 50, ensuring that the steering wheel armature 30 does not rotate beyond its intended range of motion. This prevents oversteer and loss of control, enhancing the safety and reliability of the steer-by-wire steering assembly.

The first and second spoke end stops 140, 150 may be made of materials such as metal, plastic, or composite materials, which provide adequate strength and durability to withstand the forces exerted by the at least one spoke 50 during steering operation. Alternatively, the first and second spoke end stops 140, 150 may be made of a dampening material such as rubber or silicon so that both the component housing 130 and the spoke 50 is protected.

In some examples, the first and second spoke end stops 140, 150 may be adjustable or customizable, allowing the range of motion of the steering wheel armature 30 to be modified based on driver preference, vehicle type, or driving conditions. This feature may provide added versatility and adaptability for various driving scenarios and requirements.

By removing the clockspring and providing the hand wheel actuator 100 for a steer-by-wire steering assembly, the mass and inertia can be reduced in the steering wheel armature 30. This means that the steering wheel armature 30 can be easier to turn for the user.

In another example, two or more examples are combined. Features of one example can be combined with features of other examples.

Examples of the present disclosure have been discussed with particular reference to the examples illustrated. However it will be appreciated that variations and modifications may be made to the examples described within the scope of the disclosure.

1. A handwheel actuator for a steer-by-wire steering assembly comprising:
a steering column having a steering column shaft;
a steering wheel armature having at least one spoke mounted to the steering column shaft wherein the at least one spoke is rotatable from a first spoke position to a second spoke position; and
a component protruding through the steering wheel armature and fixed with respect to the steering column, wherein the component is positioned outside the range of movement of the at least one spoke such that when the at least one spoke moves between the first spoke position and the second spoke position, the at least one spoke does not contact the component.

2. The handwheel actuator according to claim 1, wherein the steering wheel armature is rotatable less than 180 degrees in a first rotation direction and a second rotation direction from a central position.

3. The handwheel actuator according to claim 2, wherein the range of motion of the steering wheel armature is between 90 degrees and 150 degrees in the first rotation direction and the second rotation direction.

4. The handwheel actuator according to claim 1, further comprising a rim mounted to the steering column shaft and providing a surface for a driver to grip onto.

5. The handwheel actuator according to claim 1, further comprising a steering wheel cover covering and protecting the at least one spoke.

6. The handwheel actuator according to claim 1, wherein the component is an electrical component selected from the group consisting of a motor, an encoder, a sensor, control circuitry, a communication module, error detection and correction circuitry, diagnostic and monitoring circuitry, safety features, an airbag, a display screen, a mobile interaction device, and a speedometer.

7. The handwheel actuator according to claim 6, wherein the sensor is selected from the group consisting of a torque sensor, a position sensor, an accelerometer sensor, a gyroscope sensor, a force sensor, a temperature sensor, a Hall Effect sensor, an optical encoder sensor, a magnetic encoder sensor, and a potentiometer sensor.

8. The handwheel actuator according to claim 1, further comprising an electrical and data connection mounted through the steering wheel armature.

9. The handwheel actuator according to claim 1, further comprising a steer-by-wire steering actuator configured to translate electronic signals received from the steering wheel armature into physical steering movements of a vehicle.

10. The handwheel actuator according to claim 1, further comprising an electronic control unit connected to the electrical and data connection.

11. The handwheel actuator according to claim 10, further comprising a steering angle sensor electrically connected to the electronic control unit and configured to measure the angle of the steering column shaft and the direction in which it is turning.

12. The handwheel actuator according to claim 11, wherein the steering angle sensor is selected from the group consisting of a magnetic field steering angle sensor, an optical steering angle sensor, an ultrasonic steering angle sensor, a capacitive steering angle sensor, a piezoresistive steering angle sensor, a fibre optic steering angle sensor, and a rotary transformer steering angle sensor.

13. The handwheel actuator according to claim 1, further comprising a component housing mounted fixed with respect to the steering column and configured to protect the component mounted inside or around the component housing.

14. The handwheel actuator according to claim 1, further comprising a first spoke end stop configured to engage the at least one spoke when the at least one spoke is in the first spoke position and prevent further movement of the at least one spoke in the first rotation direction.

15. The handwheel actuator according to claim 1, further comprising a second spoke end stop configured to engage the at least one spoke when the at least one spoke is in the second spoke position and prevent further movement of the at least one spoke in the second rotation direction.

16. A steering wheel armature assembly for a handwheel actuator comprising:
a steering wheel armature having at least one spoke mountable to a steering column shaft wherein the at least one spoke is rotatable from a first spoke position to a second spoke position when mounted to the steering column shaft; and
a component protruding through the steering wheel armature and configured to be fixed with respect to a steering column wherein the component is positioned outside the range of movement of the at least one spoke such that when the at least one spoke moves between the first spoke position and the second spoke position the at least one spoke does not contact the component.
